(19) United States
(12) Patent Application Publication
(10) Pub. No.: US 2021/0259331 A1
(43) Pub. Date: Aug. 26, 2021

(54) ARTICLE OF MANUFACTURE AND METHOD FOR MAKING WOMEN'S PANT

(71) Applicant: Cameron Harvey, Bow, NH (US)

(72) Inventor: Cameron Harvey, Bow, NH (US)

(21) Appl. No.: 16/797,873

(22) Filed: Feb. 21, 2020

(51) Int. Cl. A41D 1/06; A41H 1/02; A41H 3/04

(52) U.S. Cl. CPC A41D 1/06; A41H 3/04; A41H 1/02

(57) ABSTRACT

A min-brush for use in cleaning and clearing obstacles from within a carryover tube in a furnace. The brush having a handle coupled to a first end of a flexible shaft, a guide point coupled to a second end of the flexible shaft, and a plurality of bristles coupled along a length of the flexible shaft, the plurality of bristles having a first side located adjacent to the guide point and extending along the flexible shaft towards the handle. The flexible shaft is a stranded cable wire permitting the guide point and the bristles to navigate a 90-degree corner through a tube

### TECHNICAL FIELD

This application relates in general to a method and article of manufacture for making women's pants.

### BACKGROUND

Women of all ages can't find pants that fit. Women typically have tremendous variability in hip, butt, thigh, and leg size. Women end up buying pants that fit their hips but not their waist, or their length but not their booty, etc. They can't control booty, waist, length, or thigh size independently on a pair of pants.

The present invention attempts to address the existing limitations in existing methods size and shape women's pants according to the principles and example embodiments disclosed herein.

### SUMMARY

In accordance with the present invention, the above and other problems are solved by providing an article and method of manufacture for women's pants that attempts to size and shape the pants to more accurately fit various women's body shapes.

In one embodiment, the present invention is an article of manufacture of a pair of women's pants. The pair of pants includes a waist measurement corresponding to the top of the pants, an inseam measurement corresponding to a length of the legs from a point where the two legs meet at the body to the bottom of the leg, a booty measurement corresponding a measurement across the body at a widest point of the hips, and a thigh measurement corresponding to a measurement of the width of each of the two legs at their widest point.

In another embodiment, the present invention is a method of manufacture of women's pants. The method obtains a waist measurement corresponding to the top of the pants, obtains an inseam measurement corresponding to a length of the legs from a point where the two legs meet at the body to the bottom of the leg, obtains a booty measurement corresponding a measurement across the body at a widest point of the hips, obtains a thigh measurement corresponding to a measurement of the width of each of the two legs at their widest point, and constructs the pair of pants using the waist measurement, the inseam measurement, the booty measurement, and the thigh measurement. The waist measurement, the inseam measurement, the booty measurement each are obtained from a particular buyer of the pants.

The great utility of the invention is that that pants may be sized and shaped to more accurately and more comfortably fit women's pants to their varying shaped body sizes.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1A-1D represent one potential embodiment of a women's pants sized and shaped illustrating the sizing measurements according to the present invention.

FIG. 2 illustrates a flow diagram of a method for making women's pants according to the present invention.

FIG. 3 illustrates a flow diagram of a method for making measurements women's pants according to the present invention.

### DETAILED DESCRIPTION

This application relates in general to a method and article of manufacture for providing an article for manufacture for women's pants.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used herein, the singular forms “a,” “an,” and “the” are intended to include the plural forms as well, unless the context clearly indicates otherwise. It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

In general, the present disclosure relates to an article for manufacture such as a women's pants shaped and sized to better fix varying body size shapes. These pants are constructed using different sizing measurements than are typically measured and used to determine the size and shape of the pants.

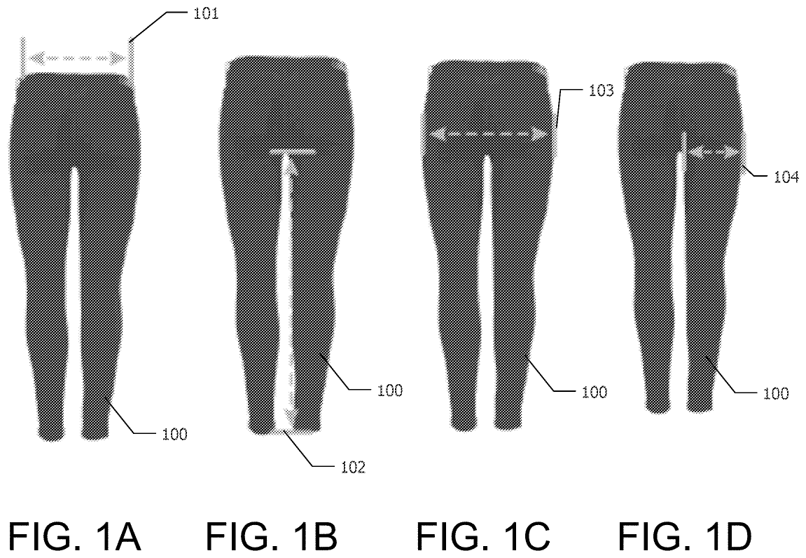

To better understand the present invention, FIGS. 1A-1D represent one potential embodiment of a women's pants sized and shaped illustrating the sizing measurements according to the present invention. This figure contains four (4) size measurements used to size and shape the pants. Each of these four measurements are identified as FIG. 1A-1D. FIG. 1A illustrates a waist measurement. This waist measurement is made at the top of the pants from side to size. This measurement is similar to measurements typically used in sizing woman's pants. This measurement may be made using a measurement made on the buyer herself or may be made on pair of pants known to fix the buyer of a particular size. This measurement may be made in inches or centimeters. In alternate embodiments, the inseam measured in inches or centimeters may be translated into various sizes even numbered sized between 24 and 34, or any number of increments as needed to define pants that properly fix a particular woman. These sizes may correspond to the waist measurement in inches or an arbitrary size naming convention.

FIG. 1B illustrates an inseam measurement. This inseam measurement is made at the inside top of the pants at the point in which the two separate legs meet to the bottom of the pant leg. This measurement is similar to measurements typically used in sizing woman's pants. As with the waist, this inseam measurement may be made using a measurement made on the buyer herself or may be made on pair of pants known to fix the buyer of a particular size. This measurement may be made in inches or centimeters. In alternate embodiments, the inseam measured in inches or centimeters may be translated into various sizes such as short, normal, and long, or any number of increments as needed to define pants that properly fix a particular woman.

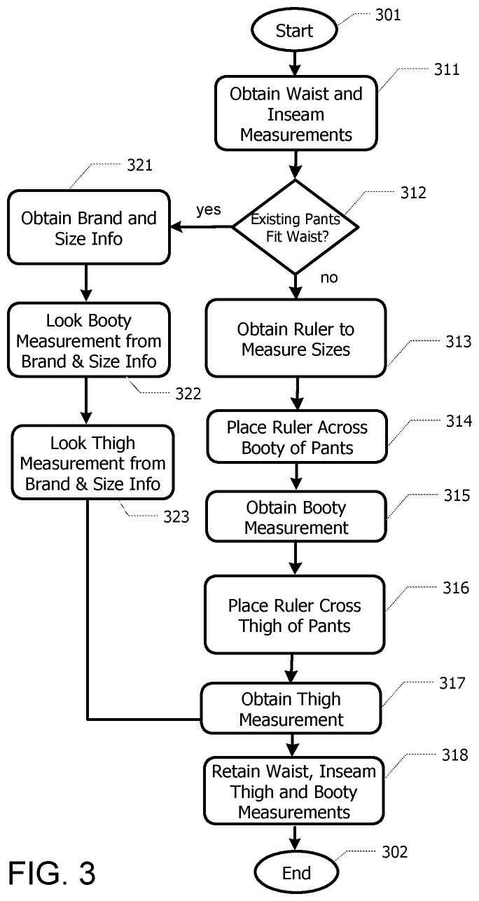

FIG. 1C illustrates a booty measurement. This booty measurement is usually made at the widest part of hips across the rear end part of the pants. How this measurement is made is discussed below in reference to FIG. 3. Adjusting this measurement of each pair of pants independent of the size of the waist measurement permits better fitting and more comfortable pants permitting a pair of pants that fits a woman's booty more exactly.

As with the waist, this booty measurement may be made using a measurement made on the buyer herself or may be made on pair of pants known to fix the buyer of a particular size. This measurement may be made in inches or centimeters. In alternate embodiments, the inseam measured in inches or centimeters may be translated into various sizes such a sequence of numbers, as above, as needed to define pants that properly fix a particular woman. Table 1 below illustrates one possible sizing for the booty measurement comparted to a particular pair of pants from a commonly available manufacturer, Levi's 720 Super Skinny pants. Of course, any pants sizes from a known source may be used to make a similar size translation.

TABLE 1

| New | Levi's 720 Super | |
|---|---|---|
| Sizes | Skinny Size | Inches |
| 15 | 25 | ?? Can you define these in |
| | | inches? |
| 16 | 26 | ?? |
| 17 | 27 | ?? |
| 18 | 29 | ?? |
| 19 | 30 | ?? |
| 20 | 32 | ?? |
| 21 | 34 | ?? |

FIG. 1D illustrates a thigh measurement. This thigh measurement is usually made at the widest part of each leg. How this measurement is made is discussed below in reference to FIG. 3. This thigh measurement allows women to select standardized measurements from 8-15, just like they already do with waist size. Big quads and small quads are sized and shaped differently, and this measurement allows pants to be contoured to better fix different legs. Table 2 below illustrates one possible sizing for the booty measurement comparted to a particular pair of pants from a commonly available manufacturer, Levi's 720 Super Skinny pants. Of course, any pants sizes from a known source may be used to make a similar size translation.

TABLE 2

| New | Levi's 720 Super | |
|---|---|---|
| Size | Skinny Waist | Inches |
| 8 | 25 | ?? Can you define these in |
| | | inches? |
| 9 | 27 | ?? |
| 10 | 30 | ?? |
| 11 | 32 | ?? |
| 12 | 34 | ?? |

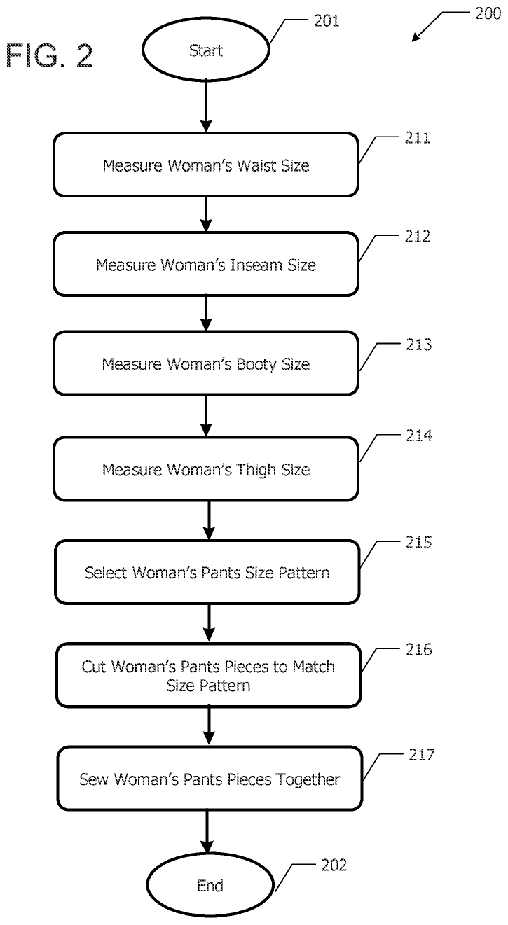

FIG. 2 illustrates a flow diagram of a method for making women's pants according to the present invention. The method begins 201 and a woman's size measurement is made in step 211. As noted above, this waist measurement is made at the top of the pants from side to size. This measurement is similar to measurements typically used in sizing woman's pants. This measurement may be made using a measurement made on the buyer herself or may be made on pair of pants known to fix the buyer of a particular size. This measurement may be made in inches or centimeters. In alternate embodiments, the inseam measured in inches or centimeters may be translated into various sizes even numbered sized between 24 and 34, or any number of increments as needed to define pants that properly fix a particular woman. These sizes may correspond to the waist measurement in inches or an arbitrary size naming convention.

In step 212, a woman's inseam is measured. As noted above, this waist measurement is made at the top of the pants from side to size. This inseam measurement may be made using a measurement made on the buyer herself or may be made on pair of pants known to fix the buyer of a particular size. This measurement may be made in inches or centimeters. In alternate embodiments, the inseam measured in inches or centimeters may be translated into various sizes such as short, normal, and long, or any number of increments as needed to define pants that properly fix a particular woman.

A booty measurement is made in step 213. This booty measurement may be made using a measurement made on the buyer herself or may be made on pair of pants known to fix the buyer of a particular size. This measurement may be made in inches or centimeters. In alternate embodiments, the inseam measured in inches or centimeters may be translated into various sizes such a sequence of numbers, as above, as needed to define pants that properly fix a particular woman. Table 1 above illustrates one possible sizing for the booty measurement comparted to a particular pair of pants. Of course, any pants sizes from a known source may be used to make a similar size translation.

Next, a thigh measurement is made in step 214. This thigh measurement is usually made at the widest part of each leg. How this measurement is made is discussed below in reference to FIG. 3. This thigh measurement allows women to select standardized measurements from 8-15, just like they already do with waist size. Big quads and small quads are sized and shaped differently, and this measurement allows pants to be contoured to better fix different legs. Table 2 below illustrates one possible sizing for the booty measurement comparted to a particular pair of pants from a commonly available manufacturer. Of course, any pants sizes from a known source may be used to make a similar size translation.

Step 215 utilizes the waist, inseam, booty, and thigh measurements to select a corresponding pattern for women's pants best fitting a woman having these measurements. The pattern illustrates the shape of each piece of fabric used to construct this particular sized pair of pants. In one embodiment, the pattern consists of a paper indication of size and shape of each piece of fabric. The pattern piece may be placed upon fabric to indicate how a larger piece of fabric may be cut to the proper size and shape. In alternate embodiments, the outline of each piece may be marked onto a large piece of fabric using a temporary marking such as chalk. This temporary marking may be manually made on the fabric by an individual using an outline template and a marking device. The temporary marking may also be made using automated, computer-controlled machinery that moves over a tightly stretched piece of fabric that permits the temporary marking to be place onto the fabric by s marking device. The marking device may consist of a piece of chalk or an aerosol jet capable of placing the temporary marking on to the fabric at particular locations under the control of a programmable computing device.

The use of programmable computing device to place the temporary markings and thus individually create pants sized and shaped to match measurements from each individual permits a manufacturer to create pants on demand that are perfectly sized for each buyer when an order for a pair of pants is made. Only pants that are orders are fabricated eliminating excess inventory and losses due to errors in demand estimates made when retailers stock stores.

The use of programmable computing device may also allow the computing device to calculate the pattern, and thus the location where the temporary markings are to be placed, for each pair of pants that eliminates the need for physical patterns of numerous measurement combinations.

Step 216 cuts the pieces from the single piece of fabric and the pieces are sewn together in step 217 to complete the pair of pants. One of ordinary skill in the art will recognize that the use of a programmable computing device may be used to cut the pieces used to construct the pants without the need for making the temporary markings of step 215. In this alternate embodiment, a cutting device is moved to the positions over the fabric in which the temporary marking is to be made and a cut is made in place of the placing of the temporary marking. Once the pieces sewn together the pants may be shipped to the buyer and the process ends 202.

FIG. 3 illustrates a flow diagram of a method for making measurements women's pants according to the present invention. The method of obtaining measurements begins with the obtaining of the waist and inseam measurements in step 311. These measurements may be obtained as discussed above in FIG. 2.

Test step 312 determines whether a known size of a particular pair of pants identified by the manufacturer as being acceptable is one of the pants known by the buyer to fit properly. If not, a ruler is obtained to make measurements on an existing pair of paints know to fit properly in step 313. This ruler may be a tale measure, cloth ruler, a wooden yardstick, or similar measuring devices.

In step 314, the existing pair of pants is laid out to permit a measurement be made with the ruler obtained above and it is placed across the back of the pants at the widest point of the hips. The booty measurement is made in step 315. As discussed above, these measurements may be in inches, centimeters, or similar units.

In step 316, the existing pair of pants is laid out to permit a measurement be made with the ruler obtained above and it is placed across the back of the pant legs at its widest point. The thigh measurement is made in step 317. As also discussed above, these measurements may be in inches, centimeters, or similar units.

Once the four measurements are obtained, step 318 stores the measurements for later use to manufacturer the new pants and the process ends 302. This recording of the measurements may be in electronic form via a message such as an email or SMS message, via entries onto a web page submitted to the manufacturer, or in written form on an order document that is sent to the manufacturer as part of an order.

Returning to step 312, if the test step determines that a known sizes of a particular pair of pants identified by the manufacturer as being acceptable is one of the pants known by the buyer to fit properly, step 321 obtains a brand and size information for pants known to ft the buyer in a desired manner. These known brand and sizes must be a brand and size combination also known to the manufacturer such that a desired size of the new pants may be determined. In many embodiments, the manufacturer will publish a list of acceptable brand and size combination that are known to be acceptable and the buyer may determine if a brand and size combination that is known to properly fix is on the list of approved pants brand and size combinations.

Step 322 looks up the new pants size to be used for the booty measurement of pants to be manufactured using the brand and size information from the buyer. Step 323 looks up the new pants size to be used for the thigh measurement of the pants to be manufactured using the brand and size information from the buyer. The processing proceeds to step 318 to store the four measurements for later use as described above and the process ends 302.

While the above embodiments of the present invention describe an article for manufacture, and a corresponding method of manufacture, of women's pants, one skilled in the art will recognize that the use various waist, inseam, booty and thigh measurements may be used with the present invention as claimed. It is to be understood that other embodiments may be utilized, and operational changes may be made without departing from the scope of the present invention.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A pair of women's pants manufactured on demand for a particular individual having two pairs of legs and a body, the pants comprising:
a waist measurement corresponding to the top of the pants;
an inseam measurement corresponding to a length of the legs from a point where the two legs meet at the body to the bottom of the leg;
a booty measurement corresponding a measurement across the body at a widest point of the hips; and
a thigh measurement corresponding to a measurement of the width of each of the two legs at their widest point.

2. The pair of women's pants according to claim 1, wherein the waist, inseam, booty, and thigh measurements are specified in measuring units obtained by measuring a buyer.

3. The pair of women's pants according to claim 1, wherein the waist, inseam, booty, and thigh measurements are specified in measuring units obtained by measuring a buyer pair of pants known to fit in a desired manner.

4. The pair of women's pants according to claim 1, wherein, the waist, inseam, booty, and thigh measurements are specified in measuring units obtained by using known measurements from a brand and size combination known by the buyer to fit in a desired manner.

5. The pair of women's pants according to claim 4, wherein the brand and size combination known by the buyer to fit in a desired manner used to specify the booty measurement differs from the brand and size combination known by the buyer to fit in a desired manner used to specify the waist measurement.

6. The pair of women's pants according to claim 4, wherein the brand and size combination known by the buyer to fit in a desired manner used to specify the booty measurement differs from the brand and size combination known by the buyer to fit in a desired manner used to specify the thigh measurement.

7. A method of manufacturing a pair of women's pants, the method comprising:
obtaining a waist measurement corresponding to the top of the pants;
obtaining an inseam measurement corresponding to a length of the legs from a point where the two legs meet at the body to the bottom of the leg;
obtaining a booty measurement corresponding a measurement across the body at a widest point of the hips; and
obtaining a thigh measurement corresponding to a measurement of the width of each of the two legs at their widest point; and
constructing the pair of pants using the waist measurement, the inseam measurement, the booty measurement, and the thigh measurement;
wherein the waist measurement, the inseam measurement, the booty measurement are obtained from a particular buyer of the pants.

8. The method according to claim 7, wherein the constructing step comprises the steps of:
determining a pants pattern for the pair of pants using the waist measurement, the inseam measurement, the booty measurement;
cutting one or more pieces of fabric from a larger piece of fabric using the pants pattern; and
combining the one or more pieces of fabric to construct the pair of pants.

9. The method according to claim 7, wherein the waist, inseam, booty, and thigh measurements are specified in measuring units obtained by measuring a buyer.

10. The method according to claim 7, wherein the waist, inseam, booty, and thigh measurements are specified in measuring units obtained by measuring a buyer pair of pants known to fit in a desired manner.

11. The method according to claim 7, wherein, the waist, inseam, booty, and thigh measurements are specified in measuring units obtained by using known measurements from a brand and size combination known by the buyer to fit in a desired manner.

12. The method according to claim 11, wherein the brand and size combination known by the buyer to fit in a desired manner used to specify the booty measurement differs from the brand and size combination known by the buyer to fit in a desired manner used to specify the waist measurement.

13. The method according to claim 11, wherein the brand and size combination known by the buyer to fit in a desired manner used to specify the booty measurement differs from the brand and size combination known by the buyer to fit in a desired manner used to specify the thigh measurement.

14. The method according to claim 8, wherein the determining the pants pattern comprises selecting from a plurality of patterns using the waist measurement, the inseam measurement, the booty measurement obtained from the particular buyer of the pants.

15. The method according to claim 8, wherein the determining the pants pattern comprises generating a unique pattern by a programmable computing device using the waist measurement, the inseam measurement, the booty measurement obtained from the particular buyer of the pants.
